(19) United States
(12) Patent Application Publication
(10) Pub. No.: US 2017/0001636 A1
(43) Pub. Date: Jan. 5, 2017

(54) Automated Vehicle Response To Imminent Rear-End Collision

(71) Applicant: Delphi Technologies, Inc., Troy, MI (US)

(72) Inventors: Michael H. Laur, Mission Viejo, CA (US); Indu Vijayan, Sunnyvale, CA (US)

(21) Appl. No.: 14/789,285

(22) Filed: Jul. 1, 2015

(51) Int. Cl. B60W 30/09; B60W 10/20; B60W 10/18

(52) U.S. Cl. CPC B60W 30/09; B60W 10/18; B60W 10/20; B60W 2710/20; B60W 2710/18; B60W 2750/308

(57) ABSTRACT

A system for automated operation of a host-vehicle includes a vehicle-control device, an object-detection device, and a controller. The vehicle-control device is operable to control one or more of acceleration of the host-vehicle, braking of the host-vehicle, and steering of the host-vehicle. The object-detection device is operable to detect a rearward-vehicle located behind the host-vehicle. The controller is configured to determine when the object-detection device indicates that a rear-end collision into the host-vehicle by the rearward-vehicle is imminent, and operate the vehicle-control device to reduce the effect of the rear-end collision experienced by an operator of the host-vehicle when the rear-end collision is imminent.

### TECHNICAL FIELD OF INVENTION

This disclosure generally relates to a system for automated operation of a host-vehicle, and more particularly relates to a system that determines when a rear-end collision is imminent, and then operates the host-vehicle in a manner selected to reduce the effect of a rear-end collision experienced by an operator of the host-vehicle.

### BACKGROUND OF INVENTION

Whiplash and other injuries can be suffered by occupants of a host-vehicle that is rear-ended by a rearward-vehicle approaching from behind the host-vehicle. Rear-end collisions are often the result of the operator of the rearward-vehicle tailgating and/or being distracted by, for example, a text message or a child in the rearward-vehicle. Ice covered roads that are undetected as being so by the operator of the rearward-vehicle can also lead to rear-end collisions. Unfortunately, the operator of the host-vehicle that is rear-ended often has no advanced warning or knowledge that the host-vehicle is about to be rear-ended, i.e. that a rear-end collision is imminent.

### SUMMARY OF THE INVENTION

As vehicles become more automated, progressing from partially automated to fully automated where an operator of a host-vehicle is little more than a passenger, the vehicle systems that keep track of objects and other vehicles forward of and beside the host-vehicle can also keep track of traffic situations behind the host-vehicle, and take evasive or remedial action when rear-end collision is imminent. As used herein, the characterization of a rear-end collision as imminent includes situations when a rear-end collision is likely (e.g. greater than 50% probability) if no-action is taken by the host-vehicle (or operator thereof) that is about to be rear-ended, but could be avoided if some sort of action is taken; and situations when no possible action by the host-vehicle (or operator thereof) that is about to be rear-ended will avoid the rear-end collision. That is, the classification or characterization of a rear-end collision as imminent does not require that the rear-end collision is absolutely unavoidable, but does not exclude those situations. Described herein is a system for automated vehicles, either partially automated or fully automated (i.e. autonomous) that takes various actions with regard to acceleration/deceleration/steering of the host-vehicle to reduce the effect(s) of a rear-end collision experienced by an operator (occupant, passenger) of the host-vehicle. As will be described in more detail herein, an action taken by the host-vehicle may not prevent the rear-end collision, but may serve to lessen the impact and thereby reduce the effect(s) of a rear-end collision experienced by the operator of the host-vehicle.

In accordance with one embodiment, a system for automated operation of a host-vehicle is provided. The system includes a vehicle-control device, an object-detection device, and a controller. The vehicle-control device is operable to control one or more of acceleration of the host-vehicle, braking of the host-vehicle, and steering of the host-vehicle. The object-detection device is operable to detect a rearward-vehicle located behind the host-vehicle. The controller is configured to determine when the object-detection device indicates that a rear-end collision into the host-vehicle by the rearward-vehicle is imminent, and operate the vehicle-control device to reduce the effect of the rear-end collision experienced by an operator of the host-vehicle when the rear-end collision is imminent.

In accordance with one embodiment, a system for automated operation of a host-vehicle is provided. The system includes an object-detection device, and a controller. The object-detection device is operable to detect a rearward-vehicle located behind a host-vehicle. The controller is configured to determine when the object-detection devices indicates that a rear-end collision by the rearward-vehicle into the host-vehicle is imminent, and operate the host-vehicle to reduce the effect of the rear-end collision on an occupant of the host-vehicle when the rear-end collision is imminent.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a schematic diagram of a system for automated operation of a host-vehicle in accordance with one embodiment;

FIG. 2 is a traffic scenario that may be encountered by the system of FIG. 1 in accordance with one embodiment; and

FIG. 3 is a traffic scenario that may be encountered by the system of FIG. 1 in accordance with one embodiment.

### DETAILED DESCRIPTION

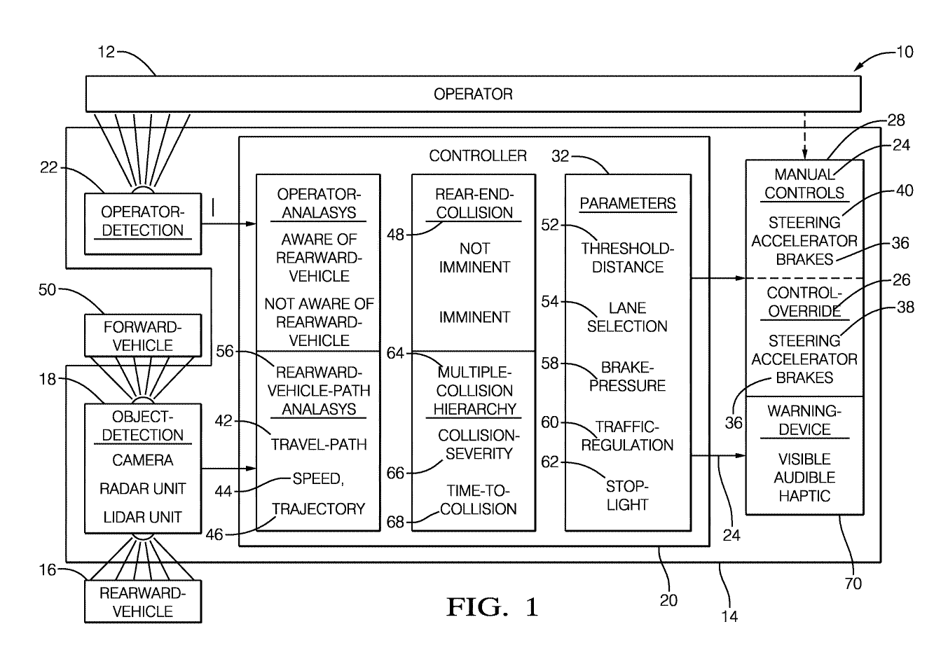

FIG. 1 illustrates a non-limiting example of a system 10 for automated operation of a host-vehicle 14. The system 10 provides for varying degrees or levels of automation to assist an operator 12 with manual-operation of a host-vehicle 14, including full automation where the operator 12 is passenger of the host-vehicle 14 does not directly influence the steering, acceleration, or deceleration of the host-vehicle 14. As will be described in more detail below, the level of assistance provided to the operator 12 by the system 10 may vary from something as simple as illuminating a warning-indicator when an rearward-vehicle 16 is approaching the host-vehicle 14, to something as complex as taking complete control of the host-vehicle 14, i.e. completely overriding the operator 12, to avoid a collision with the rearward-vehicle 16.

Accordingly, the system 10 includes an object-detection device 18 operable or useful to detect when the rearward-vehicle 16 is approaching the host-vehicle 14. The object-detection device 18 may include, but is not limited to a video camera, a radar unit, and/or a LIDAR unit suitably configured to detect various objects about the host-vehicle 14. Information gathered by the operation of the object-detection device 18 may be provided to a controller 20 for further analysis. That is, the object-detection device 18 may not by itself actually determine the location of or classification of the rearward-vehicle 16. Typically that task falls to the controller 20, but this is not a requirement of the system 10. In other words, either the object-detection device 18 or the controller 20 may perform the data or signal processing necessary to determine a relative location or classification of the rearward-vehicle 16.

The object-detection device 18 may also include a vehicle-to-vehicle (V2V) transceiver. If the rearward-vehicle 16 is another-vehicle that is also equipped with a V2V transceiver, then the system 10 may be able to notify the operator 12 that the rearward-vehicle 16 is approaching even if the operator 12 and the object-detection device 18 cannot see the rearward-vehicle 16 because the line of sight between the two is obstructed.

The controller 20 may include a processor (not specifically shown) such as a microprocessor or other control circuitry such as analog and/or digital control circuitry including an application specific integrated circuit (ASIC) for processing data as should be evident to those in the art. The controller 20 may include memory (not specifically shown) including non-volatile memory, such as electrically erasable programmable read-only memory (EEPROM) for storing one or more routines, thresholds and captured data. The one or more routines may be executed by the processor to perform steps for processing signals received by the controller 20 for operating the host-vehicle 14 as described herein.

The system 10 may include an operator-detection device 22 that is operable or useful to determine when the operator 12 of the host-vehicle 14 is aware of the rearward-vehicle 16. The operator-detection device 22 may include a camera configured to capture images of the operator 12 in the visible light spectrum and/or the infrared light spectrum, and a light source that emits light in a suitable portion of the light spectrum so the camera can see the operator 12 regardless of ambient lighting conditions. The images of the operator 12 may be processed/analyzed by the operator-detection device 22 or the controller 20 to, for example, determine if the operator 12 is farding, determine if the eyes of the operator 12 are closed indicating that the operator 12 is sleeping, determine if the head-pose of the operator varies in a manner that indicates that the operator 12 is tired, and/or determine if the eye-gaze direction of the operator 12 indicates that the operator 12 has or has not seen the rearward-vehicle 16. Image processing techniques to determine a cognitive state of the operator 12 such as where the operator is looking (eye-gaze direction) and/or if the operator 12 is alert (eye-blinking, head-pose variation) are well-known.

If the eye-gaze direction of the operator 12 is observed or determined via the operator-detection device 22 to not be in a direction that would allow the operator 12 to see the rearward-vehicle 16 directly, via a minor, or via peripheral vision, then that may be an indication that the operator 12 is not aware of the rearward-vehicle 16. If the system 10 determines that the operator 12 is not aware of the rearward-vehicle 16, and the relative location of the rearward-vehicle 16 relative to the host-vehicle 14 is such that a rear-end collision is possible, then the system 10 may take various actions to assist the operator 12 to avoid the collision with the rearward-vehicle 16.

In order for the controller 20 to be able to influence or control the position or trajectory of the host-vehicle 14 with respect to the rearward-vehicle 16 and other objects or other vehicles proximate to the host-vehicle 14, the system 10 includes a vehicle-control device 28 operable to control one or more of acceleration, braking, and steering of the host-vehicle 14. Multiple configurations of the vehicle-control device 28 are contemplated. For example, in one configuration the steering-wheel 40 may rotate as the controller 20 varies the steering direction of the host-vehicle. In this case, the system 10 may be configured so the operator 12 could physically overcome the intent of the controller 20 via the manual-controls 24.

Alternatively, the host-vehicle 14 may not have a steering-wheel or any means for the operator 12 to influence the steering direction of the host-vehicle 14. That is, the host-vehicle 14 may be configured to operate in a fully-automated or autonomous mode where the operator 12 of the host-vehicle 14 cannot influence the manual-controls 24 that control acceleration, braking, or steering of the host-vehicle 14, so the controller 20 may have total or absolute control of the manual-controls 24. As another alternative, the vehicle-control device 28 may include a control-override 26 be able to decouple the steering-wheel 40 from the steering mechanism that controls the steering direction of the host vehicle 14 and thereby override any attempt by the operator 12 to influence or otherwise steer the host-vehicle 14.

By way of example and not limitation, the control-override 26 of the vehicle-control device 28 may include one or more of an accelerator-control device 30 operable to over-ride operation of an accelerator-pedal 32 by an operator of the host-vehicle 14; a brake-control device 34 operable to over-ride operation of a brake-pedal 36 by the operator of the host-vehicle 14; and a steering-control device 38 operable to over-ride operation of a steering-wheel 40 by the operator of the host-vehicle 14.

With the information from the an object-detection device 18 to detect the rearward-vehicle 16 located behind the host-vehicle 14, the controller 20 may be equipped or programmed to determine or perform a rearward-vehicle-path analysis 56 to project a travel-path 42 of the rearward-vehicle 16 based on, but not limited to, a speed 44 and a trajectory 46 of the rearward-vehicle 16. This information may be provided to a rear-end-collision estimator 48 that determines if a rear-end collision is not imminent or is imminent.

It should be recognized that references to a rear-end collision does not mean that a collision has occurred. Rather, it means that circumstances are such that a rear-end collision is possible. As used herein, the characterization of a rear-end collision as imminent includes situations when a rear-end collision is likely (e.g. greater than 50% probability) if no intervening action is taken by the operator 12 or the host-vehicle 14 via the vehicle-control device 28. That is, a possible rear-end collision may be characterized as imminent even if the collision could be avoided by the operator 12 and/or the host-vehicle 14 taking some sort of intervening action. Also, situations when no possible action by the host-vehicle 14 or the operator 12 thereof will avoid the occurrence of a rear-end collision are characterized as imminent. That is, the classification or characterization of a rear-end collision as imminent does not require that the rear-end collision is absolutely unavoidable, but does not exclude those situations.

In addition to the controller 20 being configured to determine what the object-detection device 18 indicates about the rearward-vehicle, and the rear-end-collision estimator 48 indicates that a rear-end collision into the host-vehicle 14 by the rearward-vehicle 16 is imminent, the controller 20 may be advantageously configured to operate the vehicle-control device 28 to reduce the effect of the rear-end collision experienced by the operator 12 or passengers of the host-vehicle 14. That is, as will be explained in more detail below by way of several example traffic scenarios, the controller 20 may be configured or programmed to identify or consider a variety of optional actions that the controller 20 could execute via the vehicle-control device 28 to operate the host-vehicle 14 in a manner effective to reduce the likelihood of the rear-end collision actually occurring. Furthermore, if the pending rear-end collision is unavoidable, actions by the controller may operate the host-vehicle 14 in a manner that reduces the severity of the collision and thereby possibly reduce or prevent injury to the operator 12 and any passengers.

The system 10, or more specifically the object-detection device 18, may also be configured to detect a forward-vehicle-50 traveling in front of or beside the host-vehicle 14. The forward-vehicle 50 is generally distinguished from the rearward-vehicle 16 by the fact that the forward-vehicle 50 is not behind the host-vehicle 14. As will become apparent in the example traffic scenarios described below, the action that the controller 20 takes to prevent or avoid a rear-end collision, or reduce the severity of a rear-end collision, may in some circumstances need to includes some consideration or knowledge about the location of the forward-vehicle 50 relative to the host-vehicle 14.

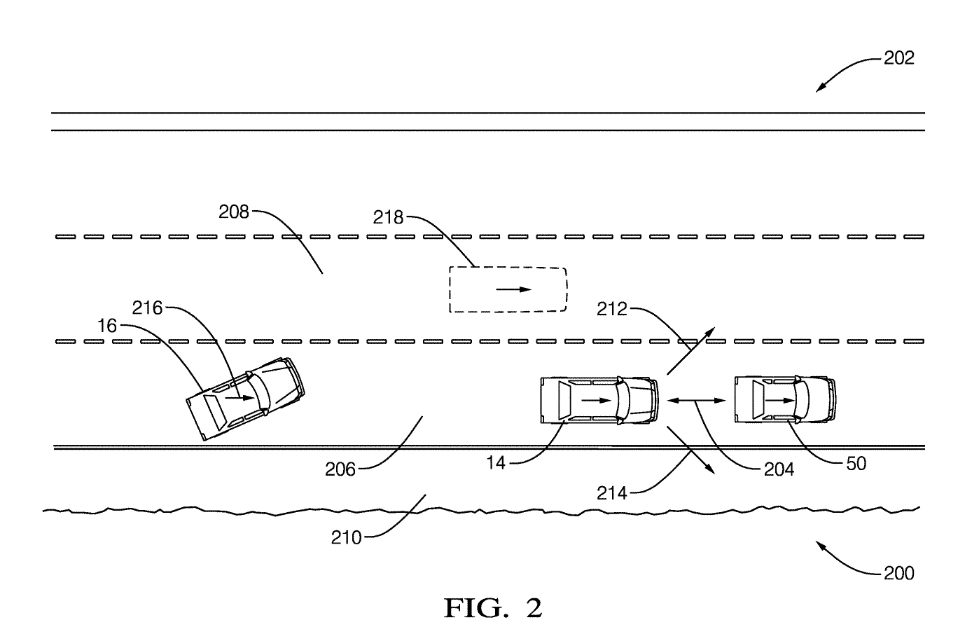

FIG. 2 illustrates a non-limiting example of a traffic scenario 200 where the host-vehicle 14, the rearward-vehicle 16, and the forward vehicle 50 are traveling on a roadway 202. In this non-limiting example, the rearward-vehicle 16 is illustrated as being oriented out of alignment with the arrow that indicates a trajectory 216 of the rearward-vehicle 16, which could occur if the roadway 202 was ice covered and the rearward-vehicle 16 was skidding and out of control. Alternatively, the rearward-vehicle 16 may be aligned with the trajectory 216, but be approaching the host-vehicle 14 at a closing-rate that suggests that driver of the rearward-vehicle 16 is not paying attention to their driving, so a rear-end collision seems to be imminent.

In general, the controller 20 is configured to operate the vehicle-control device 28 to maintain a separation-distance 204 greater than a threshold-distance 52 (FIG. 1) between the host-vehicle 14 and a forward-vehicle 50 located in front of the host-vehicle 14 when the rear-end collision is not imminent. The threshold-distance 52 may be varied based on, but not limited to, speed of the host-vehicle 14, perceived road-conditions (e.g. low-traction), and/or previously indicated preferences of the operator 12. For example, if the host-vehicle 14 and the forward-vehicle 50 are stopped, the threshold-distance may be one to two meters (1 m-2 m). However, if the host-vehicle 14 and the forward-vehicle 50 are both traveling at about one hundred kilometers-per-hour (100 kph), the threshold-distance would be significantly greater and may be determine based on a desired time-separation between the host-vehicle 14 and the forward-vehicle 50. By way of example and not limitation, a suitable value for the threshold-distance 52 when the host-vehicle 14 and the forward-vehicle 50 are both traveling at about 100 kph is sixty meters (60 m).

While not subscribing to any particular theory, it has been suggested that the severity of a rear-end collision could be reduced if the controller 20 operated the host-vehicle to decrease the separation-distance 204 to less than the threshold-distance 52 when the rear-end collision is imminent. In the case where the host-vehicle 14 and the forward-vehicle 50 are both stopped, the controller 20 may be configured to operate the vehicle-control device 28 so the host-vehicle 14 makes contact with the forward-vehicle 50 when the rear-end collision is imminent, i.e. prior to the occurrence of the rear-end collision. If contact is made, the sudden acceleration experienced by the operator 12 at the moment of impact by the rearward-vehicle 16 may be decreased because the kinetic energy transferred from the rearward-vehicle 16 would be distributed to or shared by the host-vehicle 14 and the forward-vehicle 50. I.e. the combined mass of the host-vehicle 14 and the forward-vehicle 50, plus the multiple crush zones of the host-vehicle 14 and the forward-vehicle 50 that would cooperatively absorb the kinetic energy would serve to lessen the severity of the impact experienced by the operator 12.

In the case of the host-vehicle 14 and the forward-vehicle 50 traveling at about one hundred kilometers-per-hour (100 kph), the controller 20 may be configured to accelerate the host-vehicle 14 prior to the rear-end collision so the speeds of the host-vehicle 14 and the rearward-vehicle 16 were more closely matched at the time of impact. Having the speeds more closely matched would lessen the severity of impact, as will be recognized by those in the art. It is recognized that the timing and amount of acceleration by the host-vehicle 14 would need to consider the separation-distance 204 and the speeds of the host-vehicle 14 and the forward-vehicle 50.

Continuing to refer to FIG. 2, another option is to have the controller 20 be programmed or configured to operate the vehicle-control device 28, in particular the steering-control device 38 to steer the host-vehicle 14 along a travel-lane 206 of the roadway 202 based on a lane selection 54 (FIG. 1) when the rear-end collision is not imminent. However, when the rear-end collision is imminent, the controller 20 may be programmed or configured to operate the vehicle-control device 28 to steer the host-vehicle 14 into an adjacent-lane 208 adjacent the travel-lane 206 as indicated by the arrow 212, or to steer the host-vehicle 14 into a shoulder 210 of the roadway 202 adjacent the travel-lane 206 as indicated by the arrow 214. Note that in the scenario describe above, the other-vehicle 218 is not present, and a situation when the other-vehicle 218 is present is considered later in this document.

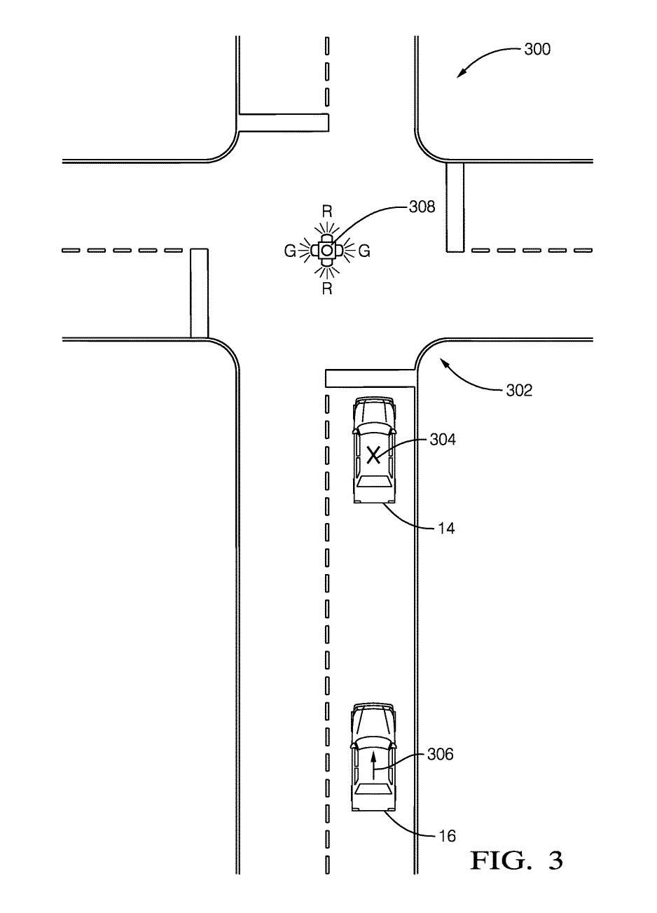

FIG. 3 illustrates a non-limiting example of a traffic scenario 300 where the host-vehicle 14 is stopped at an intersection 302, as indicated by the X 304, the rearward-vehicle 16 is traveling toward the intersection, as indicated by the arrow 306. The intersection 302 includes a traffic-light 308 that is displaying a red-light R towards the host-vehicle 14 indicating that the host-vehicle 14 should shop, and a green-light G towards cross-traffic (none shown) traveling in a direction perpendicular to that of the host-vehicle 14 and the rearward-vehicle 16.

If the host-vehicle 14 is, for example, operating in a fully-automated mode, the controller may be configured to operate the vehicle-control device 28 to control a brake-pressure 58 of the host-vehicle 14 to a hold-pressure that is sufficient to keep the host-vehicle 14 stopped at the intersection 302 when a rear-end collision is not imminent. While not subscribing to any particular theory, it is believed that unnecessarily operating a vehicle brake-system at maximum-pressure to hold a vehicle stopped exposes the brake-system to unnecessary stress that may cause premature degradation of the brake-system. The controller 20 may be pre-programmed with the hold-pressure, or the hold-pressure may be learned by the controller 20 through experience. However, if information output by the object-detection device 18 and analyzed by the rearward-vehicle-path analysis 56 causes the rear-end-collision estimator 48 to determine that a rear-end collision is imminent, the controller 20 may operate the brake-control device 34 to increase the brake-pressure 58 to greater than the hold-pressure when the rear-end collision is imminent to keep the host-vehicle 14 stopped if the rear-end collision occurs. That is, the brake-pressure 58 is increased so the host-vehicle 14 is less likely to be pushed into the intersection 302 by the rearward-vehicle 16 if a rear-end collision occurs.

In general, the controller 20 is configured to operate the vehicle-control device 28 to operate the host-vehicle 14 in accordance with a traffic-regulation 60 (preferably all traffic regulations) when the rear-end collision is not imminent. That is, under normal circumstances the controller 20 is configured or programmed to obey traffic regulations. However, when the rear-end collision is imminent, it may be preferable for the controller 20 to operate the host-vehicle in a manner that is not in accordance with the traffic-regulation 60. For example, in the situation described above, the controller 20 is configured to operate the vehicle-control device 28 to stop the host-vehicle 14 at a stop-light 62 (e.g. the traffic-light 308 when the red-light R is displayed) when the rear-end collision is not imminent.

However, if there is no cross-traffic in or approaching the intersection 302 from directions perpendicular to the travel direction of the host-vehicle 14 and the rearward-vehicle 16, it may be preferable for the controller 20 to be configured to proceed through the stop-light 62 when the rear-end collision is imminent. That is, the controller 20 may be advantageously configured to operate the host-vehicle in accordance with a traffic-light-law (i.e. remain stopped at the intersection 302 when the traffic light 308 displays a red-light R) when the rear-end collision is not imminent, and ignore the traffic-light-law when stopped and the rear-end collision is imminent. For example, if the destination of the host-vehicle 14 necessitates traveling straight through the intersection 302, the controller 20 may operate the host-vehicle 14 to proceed through the intersection 302 even though the traffic-light is displaying a red-light R. Alternatively, for the same situation, the controller 20 may execute a right-turn if the rearward-vehicle-path analysis 56 indicates that proceeding straight will not be effective to avoid the rear-end collision because the host-vehicle 14 is unable to accelerate quickly enough to avoid the rear-end collision.

It is imagined that situations may arise when any action to reduce the effect of the rear-end collision experienced by an operator 12 of the host-vehicle 14 could cause an alternative collision. For example, and referring to FIG. 2, if there is an other-vehicle 218 in the adjacent-lane 208 and close to the host-vehicle 14, and the shoulder 210 is blocked or non-existent, the option that seems to have the lowest risk of injury to the operator 12 and others in vehicles other that the host-vehicle 14 may be to steer the host-vehicle 14 in the direction shown by the arrow 212, even if doing so causes the host-vehicle 14 to contact the other-vehicle 218 in the adjacent-lane 208. That is, it may be preferable for all considered if the host-vehicle 14 intentionally makes contact with the other-vehicle 218 rather than be rear-ended by the rearward-vehicle 16. The decision to steer the host-vehicle 14 in the direction shown by the arrow 212 does not necessarily mean that the host-vehicle 14 will make contact with the other-vehicle 218 as the other-vehicle 218 may take some action such as braking and/or changing lanes to avoid contact with the host-vehicle 14.

As such, the controller 20 may be advantageously configured to determine when any action to reduce the effect of the rear-end collision experienced by the operator 12 of the host-vehicle 14 will cause an alternative collision, e.g. contact with the other-vehicle 218, and select which action to take based on a multiple-collision-hierarchy 64. The multiple-collision-hierarchy 64 may include determining a collision-severity 66 for each collision, e.g. the pending rear-end collision and any alternative collisions that may arise by the host-vehicle 14 taking action to avoid the rear-end collision. The collision-severity 66 may be a numerical ranking assigned to each option based on a predicted or projected differential speed between the host-vehicle 14 and the vehicle involved in the predicted collision being analyzed.

The multiple-collision-hierarchy may also consider a time-to-collision 68 of the rear-end collision and/or any alternative collisions being analyzed. If the time-to-collision 68 of the rear-end collision is greater than the time-to-collision of any of the alternative collisions, the controller 20 may delay taking any action and hope that the rearward-vehicle 16 will recover control and/or slow down to reduce the severity of the rear-end collision. Contrariwise, if the time-to-collision 68 of the rear-end collision is less than the time-to-collision of one of the alternative collisions, e.g. changing lanes when an approaching-vehicle (not shown) is fast approaching in a projected location of the host-vehicle after the lane change is executed, then the controller 20 may execute the lane change and hope that the approaching-vehicle will be able to take some action to avoid or lessen the severity of the alternative collision caused by the lane change.

The system 10 may also include a warning-device 70 operable to provide a warning to the operator 12 that a rear-end collision is imminent. The warning may be visible, audible, or haptic such as vibrating the seat in which the operator 12 resides. The audible warning may be verbal such as “brace for impact” or informing the operator 12 of some pending action such as “changing lanes” or “braking”.

Accordingly, a system 10 for automated operation of a host-vehicle 14, and a controller 20 for the system 10 are provided. Since the operator 12 is often less aware of what is happening behind the host-vehicle 14 compared to what is happing in front of the host-vehicle 14 while manually operating the host-vehicle 14. While the various situations (traffic scenario 200, 300) are generally described as occurring during fully-automated operation of the host-vehicle 14, it is contemplated that the teachings presented herein are applicable during partial automation where the operator 12 may be manually operating the host-vehicle, and the controller 20 may temporarily take control of the host-vehicle 14 to execute an evasive maneuver or some maneuver to lessen the severity of rear-end collision. The system 10 and controller 20 described herein are particular advantageous because some maneuvers may be complicated and/or may exceed the driving skills of the operator 12, e.g. making contact with the forward-vehicle 50 without ramming the forward-vehicle 50. Furthermore, the system 10 never gets tired, distracted, or inattentive, as may be the situation with the operator 12, particularly in regard to imminent rear-end collisions.

While this invention has been described in terms of the preferred embodiments thereof, it is not intended to be so limited, but rather only to the extent set forth in the claims that follow.

1. A system for automated operation of a host-vehicle, said system comprising:
a vehicle-control device operable to control one or more of acceleration of the host-vehicle, braking of the host-vehicle, and steering of the host-vehicle;
an object-detection device operable to detect a rearward-vehicle located behind the host-vehicle;
a controller configured to determine when the object-detection device indicates that a rear-end collision into the host-vehicle by the rearward-vehicle is imminent, and operate the vehicle-control device to reduce the effect of the rear-end collision experienced by an operator of the host-vehicle when the rear-end collision is imminent.

2. The system in accordance with claim 1, wherein the vehicle-control device consists of one or more of
an accelerator-control device operable to over-ride operation of an accelerator-pedal by an operator of the host-vehicle;
a brake-control device operable to over-ride operation of a brake-pedal by the operator of the host-vehicle; and
a steering-control device operable to over-ride operation of a steering-wheel by the operator of the host-vehicle.

3. The system in accordance with claim 1, wherein the controller is configured to operate the vehicle-control device to maintain a separation-distance greater than a threshold-distance between the host-vehicle and a forward-vehicle located in front of the host-vehicle when the rear-end collision is not imminent, and decrease the separation-distance to less than the threshold-distance when the rear-end collision is imminent.

4. The system in accordance with claim 3, wherein the controller is configured to operate the vehicle-control device so the host-vehicle makes contact with the forward-vehicle when the rear-end collision is imminent.

5. The system in accordance with claim 1, wherein the controller is configured to operate the vehicle-control device to steer the host-vehicle along a travel-lane of a roadway when the rear-end collision is not imminent, and steer the host-vehicle into one of an adjacent-lane adjacent the travel-lane and a shoulder of the roadway adjacent the travel-lane when the rear-end collision is imminent.

6. The system in accordance with claim 1, wherein the controller is configured to operate the vehicle-control device to control a brake-pressure of the host-vehicle to a hold-pressure sufficient to keep the host-vehicle stopped when the rear-end collision is not imminent, and increase the brake-pressure to greater than the hold-pressure when the rear-end collision is imminent to keep the host-vehicle stopped if the rear-end collision occurs.

7. The system in accordance with claim 1, wherein the controller is configured to operate the vehicle-control device to operate the host-vehicle in accordance with a traffic-regulation when the rear-end collision is not imminent, and not in accordance with the traffic-regulation when the rear-end collision is imminent.

8. The system in accordance with claim 7, wherein the controller is configured to operate the vehicle-control device to stop the host-vehicle at a stop-light when the rear-end collision is not imminent, and proceed through the stop-light when the rear-end collision is imminent.

9. The system in accordance with claim 1, wherein the controller is configured to determine when any action to reduce the effect of the rear-end collision experienced by the operator of the host-vehicle will cause an alternative collision, and select which action to take based on a multiple-collision-hierarchy.

10. A system for automated operation of a host-vehicle, said system comprising:
an object-detection device operable to detect a rearward-vehicle located behind a host-vehicle;
a controller configured to determine when the object-detection devices indicates that a rear-end collision by the rearward-vehicle into the host-vehicle is imminent, and operate the host-vehicle to reduce the effect of the rear-end collision on an occupant of the host-vehicle, wherein the controller is configured to maintain a separation-distance greater than a threshold-distance between the host-vehicle and a forward-vehicle located in front of the host-vehicle when the rear-end collision is not imminent, and decrease the separation-distance to less than the threshold-distance when the rear-end collision with the rearward-vehicle is imminent.

11. (canceled)

12. The system in accordance with claim 10, wherein the controller is configured to operate the host-vehicle to make contact with the forward-vehicle when the rear-end collision is imminent.

13. The system in accordance with claim 10, wherein the controller is configured to steer the host-vehicle along a travel-lane of a roadway when the rear-end collision is not imminent, and the controller is configured to steer the host vehicle into one of an adjacent-lane adjacent the travel-lane and a shoulder of the roadway adjacent the travel-lane when the rear-end collision is imminent.

14. The system in accordance with claim 10, wherein the controller is configured to operate the vehicle-control device to control a brake-pressure of the host-vehicle to a hold-pressure sufficient to keep the host-vehicle stopped when the rear-end collision is not imminent, and increase the brake-pressure to greater than the hold-pressure when the rear-end collision is imminent to keep the host-vehicle stopped if the rear-end collision occurs.

15. The system in accordance with claim 10, wherein the controller is configured to operate the host-vehicle in accordance with a traffic-light-law when the rear-end collision is not imminent, and ignore the traffic-light-law when stopped and the rear-end collision is imminent.
